(19) United States
(12) Patent Application Publication
(10) Pub. No.: US 2003/0172015 A1
(43) Pub. Date: Sep. 11, 2003

(54) Marketing technique utilising business equity

(76) Inventor: Richard John Griffin, Auckland (NZ)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/094,887

(22) Filed: Mar. 11, 2002

(51) Int. Cl. G06F 17/60

(52) U.S. Cl. 705/35; 705/36

(57) ABSTRACT

A method of establishing market share for a business (10) is disclosed. The method includes transferring ownership of a pre-determined amount of equity in the business (10) to one or more existing or potential customers (11) of the business, wherein each customer (11) provides a commitment to purchase products and/or services from the business (10) to become entitled to the transfer of equity. A periodic evaluation of the activity of each customer (11) is performed to determine whether each customer is satisfying its commitment and equity transferred to or from each customer dependent on the result of the evaluation. Each customer (11) may be a business itself. An agent (13) may receive a commission based on customers (11) that they recruit or on dividend payments that they administer. Computerised apparatus for the system is also claimed.

### BACKGROUND

This invention relates to a method of market share establishment for a business supplying product and/or services.

It is well established that most start-up businesses fail within the first few years of operations. The failure of these businesses may be attributed to a number of reasons, including lack of cash flow, lack of equity from which to obtain funds and/or insufficient market presence to support the operations of the business. Once a company is established within a market, the revenue from sales of products or services can support the operations of a business. However, until such time as the business obtains a sufficient market share, the business typically becomes prone to large negative cash flows in an effort to obtain the required market share.

The negative cashflows at the beginning of the life cycle of a business are typically funded from business equity. Sufficient business equity may be raised by investment into the business by its owners or shareholders, may be financed by debt, or a combination of these. However, the availability of funds for this purpose is often limited and the cost of debt can be high given the risk that the financiers are taking in providing funds for a start up business.

Therefore, the start-up business has significant barriers to entering a market due to restrictions on the available funds required to establish a sufficient market share to support the business.

Similarly, even established businesses can become prone to large negative cash flows during any phases of rapid expansion. If these cash flows are not managed carefully, the business runs the risk of not satisfying its debt obligations and a liquidator may be appointed by secured creditors.

Even once a business is established, in the highly competitive markets at present, holding on to market share is difficult. Therefore, it is a great advantage for a business in such a competitive market to secure a loyal market share for its products or services.

### OBJECT OF THE INVENTION

Thus, it is an object of the present invention to provide a method of market share establishment that overcomes or at least alleviates problems in business market share establishment at present.

It is a further or alternative object to provide a method of establishing a loyal market share by providing a useful reward to customers for their custom.

It is a further or alternative object to provide a computerised system to implement a method of market establishment and/or a method of establishing a loyal market share.

It is a further or alternative object to at least provide the public with a useful alternative.

Further objects of the invention may become apparent from the following description, which is given by way of example only.

### SUMMARY OF THE INVENTION

According to one aspect of the invention, there is provided a method of establishing market share for a business, the method including transferring ownership of a pre-determined amount of equity in the business to one or more existing or potential customers of the business, wherein each customer provides a commitment to purchase products and/or services from the business to become entitled to the transfer of equity.

Preferably, the method may further include periodically performing an evaluation of the activity of each customer to determine whether each customer is satisfying its commitment, the method further including transferring equity to or from each customer dependent on the result of the evaluation.

Preferably, the method may further include transferring equity from one customer to another customer and/or to the business depending on the result of the evaluation.

Preferably, the equity assigned to the customers comprises shares in the business.

Preferably, the equity assigned to each customer does not entitle the customer to any decision making power regarding the operations of the business.

Preferably, the equity assigned to the customers includes non-voting shares.

Preferably, the business equity is offered to each customer for zero or nominal monetary consideration.

Preferably, the method further includes offering the equity through at least one third party, wherein the or each third party receives a commission dependent on the customers that the third party was responsible for obtaining a commitment from.

Preferably, the or each third party receives a commission for administering the transfer of dividends from the business to the customers.

Preferably, the or each third party receives a commission dependent on the size of the order commitment from the customers which that third party was responsible for causing a share transfer to.

Preferably, the commitment is a commitment to purchase a specified quantity of goods and/or services from the business and the amount of equity transferred is dependent on the specified quantity of goods and/or services.

Preferably, the method further includes reducing or increasing the amount of equity that a customer has dependent on the orders that that customer has placed relative to their commitment over a predetermined period.

According to a second aspect of the present invention, there is provided a method of establishing market share for a business, the method including transferring ownership of a pre-determined amount of equity in the business to one or more existing or potential customers of the business for zero or nominal monetary consideration, wherein each customer provides a commitment to purchase products and/or services from the business to become entitled to the transfer of equity, periodically performing an evaluation of the activity of each customer to determine whether each customer is satisfying its commitment and transferring equity from one customer to another customer and/or to the business depending on the result of the evaluation.

Preferably, the transfer of equity from one customer to another customer is performed by a third party, said third party receiving a commission for each transfer.

According to a third aspect of the present invention, there is provided a method of establishing market share for a business, the method including transferring ownership of a pre-determined amount of equity in the business to one or more existing or potential customers of the business, wherein each customer is a business itself and provides a commitment to purchase products and/or services from the business to become entitled to the transfer of equity.

Preferably, the method may further include periodically performing an evaluation of the activity of each customer to determine whether each customer is satisfying its commitment, the method further including transferring from one customer to another customer and/or to the business depending on the result of the evaluation.

According to a fourth aspect of the present invention there is provided computerised apparatus for a market establishment system, the apparatus including:

computer memory containing information defining each of a plurality of customers and an order commitment to a business for each customer;

input means to receive information defining a quantity of orders from each customer to said business and create a record of orders for each customer in said computer memory; and

a computer able to read said computer memory, wherein the computer in use retrieves from said computer memory the order commitment and record of orders for each customer and computes a proportion of ownership of said business that a customer is entitled to according to the relative size of the order commitment and said quantity of orders for that customer.

Preferably, said computer in use outputs instructions regarding how equity should be transferred between the customers and/or the business to achieve a computed level of ownership for each customer.

Preferably, said computing means in use receives information defining a dividend payment due to each customer and computes a commission based on said dividend payment.

Further aspects of the present invention may become apparent from the following description, which is given by way of example only.

### DETAILED DESCRIPTION OF THE INVENTION

According to the present invention, a business, which is currently owned one hundred percent (100%) by its present owners conditionally offers a portion of the business equity to potential customers. The condition is that they provide a commitment to order goods and/or services from the business. This may provide benefit to the business in that it secures a market for its products and/or services and provides a benefit to the customer by assigning them ownership in the company in return for a commitment that they purchase the products or services from the business of which they now are a shareholder of.

The following description will be given using the example of a business that is in the form of a company and thus has a number of shares available for transfer to customers and some existing shareholders. This represents a preferred embodiment, but it will be appreciated by those skilled in the art that any other suitable measure of the equity of a business may be used in place of shares for the same purpose where it is appropriate for that business.

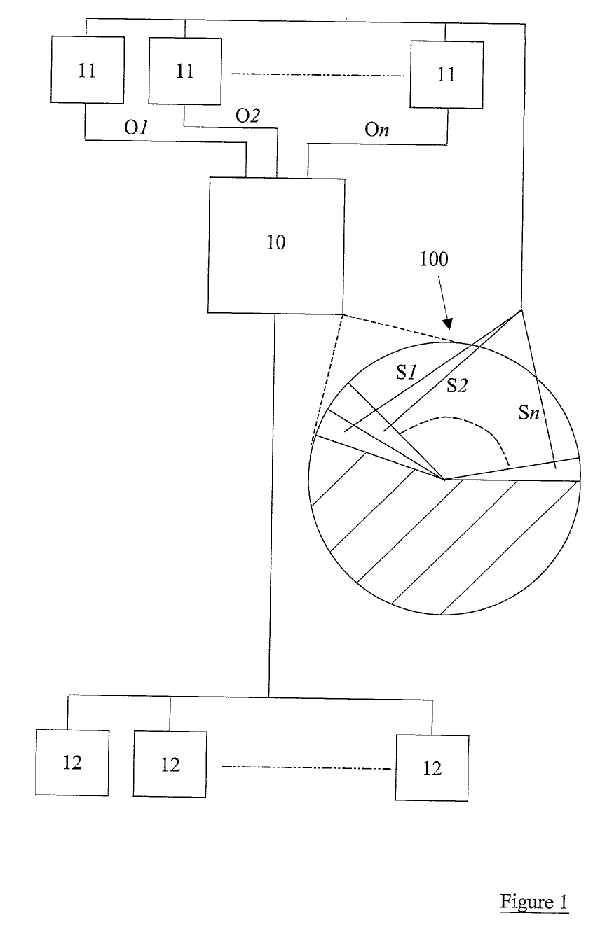

Referring to FIG. 1, a business 10 has an existing equity, represented graphically by the entirety of the pie chart 100. The business 10 has a number, n, of existing or potential customers 11, which require products and/or services from the business 10 and a number of existing shareholders 12. All or selected customers 11 are offered an equity agreement. The equity agreement offers shares in the business 10, as represented by S1, S2 and Sn, so that each customer becomes a shareholder of the business 10. Once each customer 11 provides a commitment to order from the business 10 (the orders represented by O1, O2, On), an agreed number of shares in the business 10 are transferred to the customers.

The shares may remain assigned to the customer 11 on the condition that they continue satisfying their commitment to purchase from the business 10. If this commitment is not satisfied, the shares are assigned back to the business 10. The shares may subsequently be “resold” to another potential customer, or the same customer if appropriate, for a commitment from that customer to purchase products and/or services from the business 10. Alternatively, the agreement may not require the forfeit of shares by the customer, but allow for some other remedy, such as damages for breach of contract.

Each customer 11 may be a business rather than an individual entity. In this case, the present invention may be used to promote supply chain business partnerships. Although the invention may be applied to businesses whose customers are individuals, it is anticipated that the invention will have particular application to business customers.

The number of shares issued to each customer 11 may be at least partially dependent on the order commitment that they make. For example, each customer 11 may receive a base number of shares, with additional shares being offered should they commit to a greater number of orders. The number of shares offered may be calculated using any required relationship between order commitment and equity.

The shares issued to the customers may be non-voting shares, therefore ensuring that control of the company remains with the original owners of the business 10 or persons deriving title from the original owners. These owners may maintain a specific ratio of shares owned by themselves in comparison to shares owned by customers of the business if required. Thus, referring to FIG. 1, the owners may retain 60% of all shares, shown as the shaded portion of the pie chart 100. As more customers 11 are added, the original owners may inject more equity to maintain a required percentage, or may reduce their shareholding.

If a customer 11 is exceeding its commitment, constantly meeting its commitment and/or otherwise desirous of a reward from the business 10, the customer may be offered further shares at no charge or at a reduced rate. The original owners 12 may keep some portion of the business equity in reserve in order to enable this, or may inject further equity or reduce their shareholding. The performance of each customer 11 is evaluated periodically by the business 10, or agent 13 (see herein below), so that appropriate action may be taken, if any, for example arranging a transfer of shares to or from a customer.

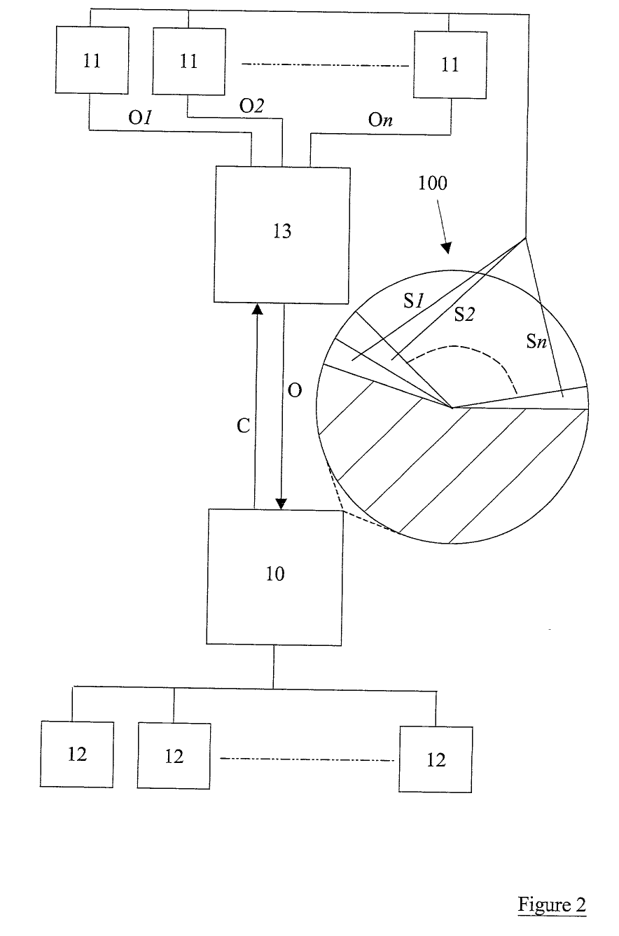

Referring to FIG. 2, an agent 13 may be utilised by the business 10 to manage the assignment of shares to its customers 11. The agent may actively market the company's products and/or services to customers 11, outlining the benefit of receiving shares in the business 10 by providing a commitment to order from that business. This benefit is in addition to the actual products and/or services provided to the customer 11. It is not anticipated that the products and/or services will be traded at any rate substantially different from what the market dictates. However, in some circumstances this may be the case. For example, when the business 10 is supplying to both shareholding and non-shareholding customers, a discounted price may be offered to the shareholding customers. This may act as a further incentive to non-shareholding customers to provide a order commitment so as to be entitled to shares and a discounted price.

The agent 13 may optionally receive orders on behalf of the business 10 and forward these to the business 10, as represented by arrow O. However, it is anticipated that in many cases the orders will be communicated directly from the customers 11 to the business 10.

The agent 13 may receive a commission for each share transfer it performs, with the commission being either paid by the business 10 as shown by arrow C, or by the customer 11. The agent 13 may receive a commission only for the obtaining of additional customers that provide a commitment, or may receive a commission for further transfers to, from or between customers 11. Also, the agent 13 may receive a commission for administering the distribution of dividends from the business 10 to its shareholding customers. A number agents 13 may be used, each receiving a commission for the customers 11 that they get to enter a commitment to purchase from the business 10. Also, each agent 13 may optionally administer the equity and/or dividends of a plurality of businesses. To avoid a conflict of interest, it may be preferable that a single agent not administer equity for competing businesses.

It will be appreciated by those skilled in the art, that once the company obtains sufficient shareholding customers so that the required balance in ownership is achieved, then further customers cannot be obtained using the incentive of offering them of shares without further reducing the ownership percentage of the original owners. Therefore, the company at this stage would have to market its products using conventional techniques, have more capital injected by the original owners 12 or reduce the shareholding of the original owners 12. By this stage, the business 10 will have a stable and potentially large customer base to support its operations and allow a significant marketing effort to be conducted in order to secure the custom of non-shareholding customers. Thus, the business 10 will be in a good position to compete in the market without having to transfer additional shares to its customers.

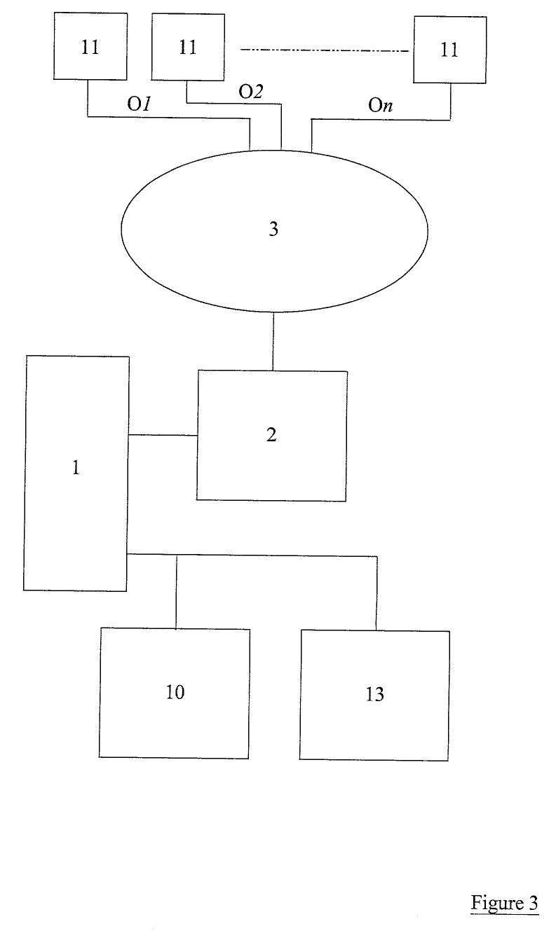

FIG. 3 shows a representation of a computerised implementation of the present invention. The business 10, and/or its agent 13 manages a computer 1, which may be connected to a web server 2 for connection to and communication through the Internet 3. The computer 1 and world-wide-web server 2 may be the same device and may be any suitable system for performing the calculations and communication functions described herein. Customers 11 through their terminals 4 and the Internet 3, lodge a request for an equity agreement to the computer 1. The equity agreement is then sent either automatically or manually as appropriate to the customer by mail, email, facsimile or similar for execution by the customer 11. Alternatively, an online agreement may be formed using a suitable web site interface if this is an acceptable method of executing the agreement in the circumstances. Each customer 11 may communicate orders to the computer 1 through the Internet 3. The computer 1 collates the orders and sends them to the business 10.

The computer 1, or associated computer system in communication with the server 2 may automatically keep records of the orders placed by each customer 11 for comparison to their order commitment. The computer 1 may calculate adjustments to the shares of each customer 11 depending on their orders. For example, if one customer is exceeding their commitment, the computer 1 may compute an increase in the shareholding dependent on the extent that the customer exceeded their order and/or the size of their total order. Periodically, a share transfer may occur. Shares may be transferred from customers that are not meeting their commitment to customers that are, with the equity of the original owners providing for any shortfall, or the equity of the shareholders increasing for any surplus.

The computer 1 may compute a commission due to the third party for establishing customers and/or for administering payment of dividends. The commission calculation may relate to the size of the order commitment from the customer in case of establishing customers and be proportionate to the dividend in the case of dividend payments. The commission may also have a fixed component per transaction if required.

In an alternative embodiment, orders from the customers 11 may be received through means other than the network, such as through facsimile, phone or mail. An operator at the business 10 may then enter the order into the computer 1 so that the computer 1 can record the transaction.

Where in the foregoing description reference has been made to specific components or integers of the invention having known equivalents then such equivalents are herein incorporated as if incorporated as if individually set forth.

Although this invention has been described by way of example and with reference to possible embodiments thereof it is to be understood that modifications or improvements may be made thereto without departing from the scope of the invention as defined in the appended claims.

What is claimed is:

1. A method of establishing market share for a business, the method including transferring ownership of a pre-determined amount of equity in the business to one or more existing or potential customers of the business, wherein each customer provides a commitment to purchase products and/or services from the business to become entitled to the transfer of equity.

2. A method of establishing market share for a business, the method including transferring ownership of a pre-determined amount of equity in the business to one or more existing or potential customers of the business, wherein each customer provides a commitment to purchase products and/or services from the business to become entitled to the transfer of equity and wherein the method further includes periodically performing an evaluation of the activity of each customer to determine whether each customer is satisfying its commitment and transferring equity to or from each customer dependent on the result of the evaluation.

3. The method of claim 2, further including transferring equity from one customer to another customer and/or to the business depending on the result of the evaluation.

4. The method of claim 1 or claim 2, wherein the equity assigned to each customer comprises shares in the business.

5. The method of claim 1, wherein the equity assigned to each customer does not entitle the customer to any decision making power regarding the operations of the business.

6. The method of claim 1, wherein the equity assigned to the customers includes non-voting shares.

7. The method of either claim 1 or claim 2, wherein the business equity is offered to each customer for zero or nominal monetary consideration.

8. The method of either claim 1 or claim 2, further including offering the equity through at least one third party, wherein the or each third party receives a commission dependent on the customers that the third party was responsible for obtaining a commitment from.

9. The method of claim 8, wherein the or each third party receives a commission for administering the transfer of dividends from the business to the customers.

10. The method of claim 8, wherein the or each third party receives a commission dependent on the size of the order commitment from the customers which that third party was responsible for causing a share transfer to.

11. The method of claim 1, wherein said commitment is a commitment to purchase a specified quantity of goods and/or services from the business and the amount of equity transferred is dependent on the specified quantity of goods and/or services.

12. The method of claim 11 further including reducing or increasing the amount of equity that a customer has dependent on the orders that that customer has placed relative to their commitment over a predetermined period.

13. A method of establishing market share for a business, the method including transferring ownership of a pre-determined amount of equity in the business to one or more existing or potential customers of the business for zero or nominal monetary consideration, wherein each customer provides a commitment to purchase products and/or services from the business to become entitled to the transfer of equity, periodically performing an evaluation of the activity of each customer to determine whether each customer is satisfying its commitment and transferring equity from one customer to another customer and/or to the business depending on the result of the evaluation.

14. The method of claim 13, wherein said transfer of equity from one customer to another customer is performed by a third party, said third party receiving a commission for each transfer.

15. The method of claim 14, wherein said third party also administers the payment of dividends to said customers and receives a commission in consideration thereof.

16. A method of establishing market share for a business, the method including transferring ownership of a pre-determined amount of equity in the business to one or more existing or potential customers of the business, wherein each customer is a business itself and provides a commitment to purchase products and/or services from the business to become entitled to the transfer of equity.

17. The method of claim 16, further including periodically performing an evaluation of the activity of each customer to determine whether each customer is satisfying its commitment, the method further including transferring from one customer to another customer and/or to the business depending on the result of the evaluation.

18. Computerised apparatus for a market establishment system, the apparatus including:
computer memory containing information defining each of a plurality of customers and an order commitment to a business for each customer; input means to receive information defining a quantity of orders from each customer to said business and create a record of orders for each customer in said computer memory; and
computing means capable of reading said computer memory, wherein the computing means in use retrieves from said computer memory the order commitment and record of orders for each customer and computes a value indicative of a level of ownership of said business that a customer is entitled to according to the relative size of the order commitment and said quantity of orders for that customer.

19. The computerised apparatus of claim 18, wherein said computer in use outputs instructions regarding how equity should be transferred between the customers and/or the business to achieve a computed level of ownership for each customer.

20. The computerised apparatus of claim 18, wherein said computing means in use receives information defining a dividend payment due to each customer and computes a commission based on said dividend payment.
